(19) United States
(12) Patent Application Publication
(10) Pub. No.: US 2013/0146501 A1
(43) Pub. Date: Jun. 13, 2013

(54) DISPOSAL SYSTEM

(71) Applicants: Kathryn H. Zusmanis, Berkeley Lake, GA (US); Eriks A. Zusmanis, Berkeley Lake, GA (US)

(72) Inventors: Kathryn H. Zusmanis, Berkeley Lake, GA (US); Eriks A. Zusmanis, Berkeley Lake, GA (US)

(21) Appl. No.: 13/649,112

(22) Filed: Oct. 11, 2012

Related U.S. Application Data
(60) Provisional application No. 61/547,548, filed on Oct. 14, 2011.

(51) Int. Cl. B65F 1/14; G07F 9/10; B65F 1/06

(52) U.S. Cl. CPC B65F 1/14; B65F 1/06; B65F 1/1623; G07F 9/10
USPC 206/525; 221/102

(57) ABSTRACT

A waste product disposal system for sanitary removal and disposal of waste product that avoids contact with the waste product and fluids or particles on the waste product, and provides a system to minimize contact with other discarded waste product during disposal. Further, the system allows easy dispensing of covering materials for handling the waste product and discarding of the waste matter. The disposal system generally includes the covering material used to enclose the waste product, a dispenser to dispense the covering material, and a waste receptacle to safely dispose of the covered waste product.

### CROSS-REFERENCE TO RELATED APPLICATIONS

This application is being filed in the United States Patent Office under 35 U.S.C. §111 and 37 C.F.R. §1.53(b) as a non-provisional application and, claiming the benefit of the filing date under 35 U.S.C. §119(e) of the United States Provisional application for patent that was filed on Oct. 14, 2011 and assigned Ser. No. 61/547,548, which application is incorporated herein by reference.

### BACKGROUND

The present disclosure relates generally to disposal systems and, more specifically, it relates to a disposal system that can be used for sanitary removal and/or disposal of waste products that can cause the spread of disease, bacteria or other harmful elements by avoiding human contact with the waste products and elements, providing a system to minimize contact with other discarded waste products during disposal and allowing easy dispensing of special tissues or materials for handling and discarding of the waste products.

### BRIEF SUMMARY OF THE INVENTION

The disclosed embodiments generally relate to a waste product disposal system which includes a covering or handling material, such as a tissue or towel or pouch, used to enclose the waste product, a dispenser to dispense the covering, and a waste receptacle to safely dispose of the covered waste product. Although specific embodiments of the waste product disposal system may be described in relationship to a specific type of waste product, such as a used tampon or the like, it should be appreciated that other embodiments can be utilized for the disposal of other items including personal, medical, etc. waste product items. Reference will now be made in detail to the embodiments of the disposal system, one or more examples of which are illustrated in the drawings. Each example is provided by way of explanation of exemplary embodiments, as well as aspects and features of various embodiments, and is not meant to be a limitation. For example, features illustrated or described as part of one embodiment can be used with another embodiment to yield still a third embodiment. It is intended that any particular embodiment may include some or all these and other modifications and variations.

There has thus been outlined, rather broadly, some of the features of the various embodiments in order that the detailed description thereof may be better understood, and in order that the present contribution to the art may be better appreciated. There are additional features of that may be incorporated into various embodiments that will be described hereinafter.

In this respect, before explaining at least one embodiment of the disposal system in detail, it is to be understood that the embodiments are not limited in their application to the details of construction or to the arrangements of the components set forth in the following description or illustrated in the drawings. The various embodiments are capable of being practiced and carried out in various ways. Also, it is to be understood that the phraseology and terminology employed herein are for the purpose of the description and should not be regarded as limiting.

One embodiment of the disposal system can be used as a tampon tissue disposal system for sanitary removal and disposal of tampons, that avoids contact with the used tampon and related bodily fluids and that provides a system to minimize contact with other discarded tampons during disposal and allows easy dispensing of special tampon tissues and discard of the waste matter.

One aspect that can be incorporated into various embodiments of the disposal system is a technique to enable the removal and/or handling of the waste product, such as a used tampon, with a special covering that prevents a user from coming into direct contact with the waste product or its contents.

Another aspect that can be incorporated into the various embodiments is technique that allows for the easy dispensing and replacement of the special covering material, such as a tissue as a non-limiting example.

Another aspect that can be incorporated into various embodiments is a hands free, touch-free mechanism that can be used to control the opening and closing of a lid or access panel to the disposal system and/or for the dispensing of the covering or handling material. Further, such mechanism can also include an automatic triggering such as a motion sensor or the like, to cause actuation of the hands free, touch-free mechanism.

Other aspects, features and advantages of the various embodiments of the disposal system will be apparent to the reader and it is intended that the described embodiments, aspects, features and advantages, as well as others are within the scope of the present invention. Thus, various embodiments may be embodied in the form illustrated in the accompanying drawings, attention being called to the fact, however, that the drawings are illustrative only, and that changes may be made in the specific construction illustrated and described within the scope of this application.

### BRIEF DESCRIPTION OF THE DRAWINGS

Various other objects, features and attendant advantages of the disclosed disposal system will become fully appreciated as the same becomes better understood when considered in conjunction with the accompanying drawings, in which like reference characters designate the same or similar parts throughout the several views, and wherein:

FIG. 1 is a front view and a back view of an exemplary embodiment of the covering material.

FIG. 2 is a conceptual diagram of another embodiment of a covering material.

FIG. 3 is an upper perspective view of an exemplary embodiment of a waste product disposal system that includes a covering material dispenser and a waste product receptacle

FIG. 4 is a functional block diagram of the components of an exemplary embodiment of system or sub-system operating as a controller or processor that could be used in various embodiments of the disclosure for controlling aspects of the various embodiments.

FIG. 5 is a diagram illustrating an embodiment of the waste product disposal system with a hands free, touch-free access to the waste product receptacle.

### DETAILED DESCRIPTION OF VARIOUS EMBODIMENTS

The present description presents a waste product disposal system that can be configured, in various embodiments, to provide a sanitary, touch-free, sterilized means for the disposal of waste product.

One aspect that can be incorporated into various embodiments of the waste disposal system is a covering or handling material that protects a user from the waste product or elements that may be on or in the waste product and a dispenser for the covering. One embodiment of this aspect is a tissue that can be used to enclose the waste product, such as a used tampon and a dispenser to dispense the tissue. Embodiments that include this aspect may also include a waste receptacle for safely dispositing of the wrapped tampon.

Another aspect that can be incorporated into various embodiments of the waste disposal system is a handsfree, touch-free mechanism for gaining access to a waste disposal area for the depositing of the waste product. Embodiments that include this aspect may also include a covering material and dispenser for the handling of the waste product.

Another aspect that can be incorporated into various embodiments of the waste disposal system is a covering material that can be used for handling of waste product. Certain features of the covering material, such as protective shielding, absorbing materials, etc. help to increase the safety and sanitary handling of the waste product. Embodiments that include this aspect may also include a dispenser, a handsfree dispenser, a waste disposal receptacle and/or a handsfree touch-free waste disposal receptacle.

Turning now descriptively to the drawings, in which similar reference characters denote similar elements throughout the several views, several embodiments, as well as aspects, features and advantages thereof are presented in more detail.

### Covering Material

In general, the present disclosure presents a covering material that facilitates the sanitary handling of waste products.

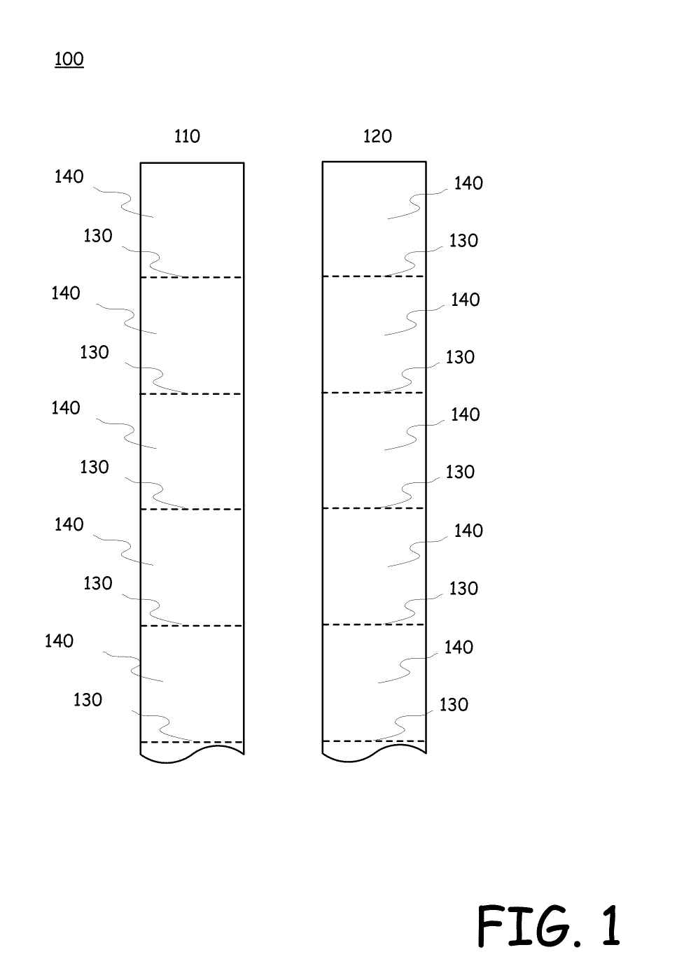

FIG. 1 is a front view and a back view of an exemplary embodiment of the covering material. In general, the illustrated embodiment consists of a double sided tissue. One side of the tissue includes a material that reduces the likelihood of elements residing on or within the waste product from coming into contact with the user. The other side of the tissue includes a material that is sufficiently absorbent to absorb fluids and reduce spilling the contents of the waste product. The absorbing material can be any of a variety of materials including cotton, non-woven fabric, sodium polyacrylate, layers of cotton, etc. In addition or in lieu of this absorbing material, the material may include a static attraction or capturing material that holds to or clings to powders or granules that may be included in the waste product. The disclosed embodiments of the tissues are disposable sheets and can be, for instance, facial tissues, paper towels, industrial wipers, laboratory wipers, wet wipes, medical wipers and the like. In addition, in some embodiments, rather than tissues the covering may be a pouch or a pocket. The described embodiments, as well as other embodiments of the disposable tissue can be utilized in various embodiments of the waste product disposal system.

For the particular embodiment illustrated in FIG. 1 in which the covering material is a tissue, the illustrated tissue 100 includes a first side 110 and a second side 120. The first side 110 of the tissue 100 may be constructed of, or include a fluid resistant material or non-porous material, hydrophobic, or other material, such as compressed cotton, wax paper, thermoplastic, plastic films, silicone, vinyl, latex, etc., sufficient to form a barrier between the waste product and theuser.

The opposing or second side 120 of the disposal system tissue 100 may be made of a variety of fluid absorbent materials or hydrophilic materials of sufficient thickness to absorb any fluids, such as bodily fluids in the example of the waste product being a used tampon. In other embodiments, the first or second side could include another material, such as a non-woven fabric, more suitable for attachment to, or clinging and holding onto dust particles, powder or similar elements. In general the tissue can be made from various materials.

In the illustrated embodiment, the covering material is constructed in a roll of martial that can be separated into individual sheets 140 by breaking the roll at the perforations 130. The covering material, however, can actually be provided in a variety of manners and a few non-limiting examples include rolls or interfolded disposable sheets such as C-folded, V-folded, Z-folded, tab-bonded or configured with respect to one another by any means commonly known in the art.

It should be appreciated that other embodiments that include a single ply with a coating, or two or more plies may also be utilized. For instance, a three ply embodiment may include a fluid resistant material in the middle ply with a highly absorbent material on one outer ply and another outer ply laced or impregnated with an anti-bacterial solution.

In another three ply embodiment, the middle ply may include a fluid resistant material, one outer ply may include a highly absorbent material, and the other outer ply may include a particle absorbing or clinging material, such as a non-woven fabric. In yet another embodiment, one side may include a fluid resistant material and the other side may include a combination of a material that is highly absorbent of liquid and particles. In yet another variation of this latter embodiment, a highly liquid absorbent material and a particle absorbent material may be interlaced such that regardless of the waste product, liquids or particles or both will be absorbed and held. In another embodiment, the covering may include a liquid absorbing material that is positioned below a particle absorbing material. In such an embodiment, the particle absorbing material, such as a non-woven fabric, can attract and hold particles and, also allow liquids to pass through to the liquid absorbing material.

Other embodiments may also be anticipated and the illustrated examples are provided for illustrative purposes only and are not limiting. In addition, in some embodiments that may be deployed in a more industrial setting, one or more layers can be constructed of a durable, material that can resist puncture, stretching or the like. Further, in a medical environment, the material can be constructed to resist punctures from a needle or syringe that is being disposed of. In a factory setting, the material may be heat resistant to allow disposal of items that may have been heated or cooled. In other embodiments, the material may include protrusions or small spikes to help grip onto slippery items. One or two sides of the material may contain a scent, odor absorbing materials or chemicals, antibacterial material, antimicrobial material and/or other products to reduce germs and/or odors.

Other embodiments may be constructed in a pouch like manner with one or two open edges or a partly open edge. Such embodiments may also include a technique for sealing of the pouch, such as a ZIPLOCK, a strip of adhesive tape with a peel-away strip, hook and loop materials, a bendable metal strip that can secure the openings in a closed position, etc. Similarly, in an embodiment that is simply in the form of a sheet, one or more sides may include such techniques for sealing of one side to the next.

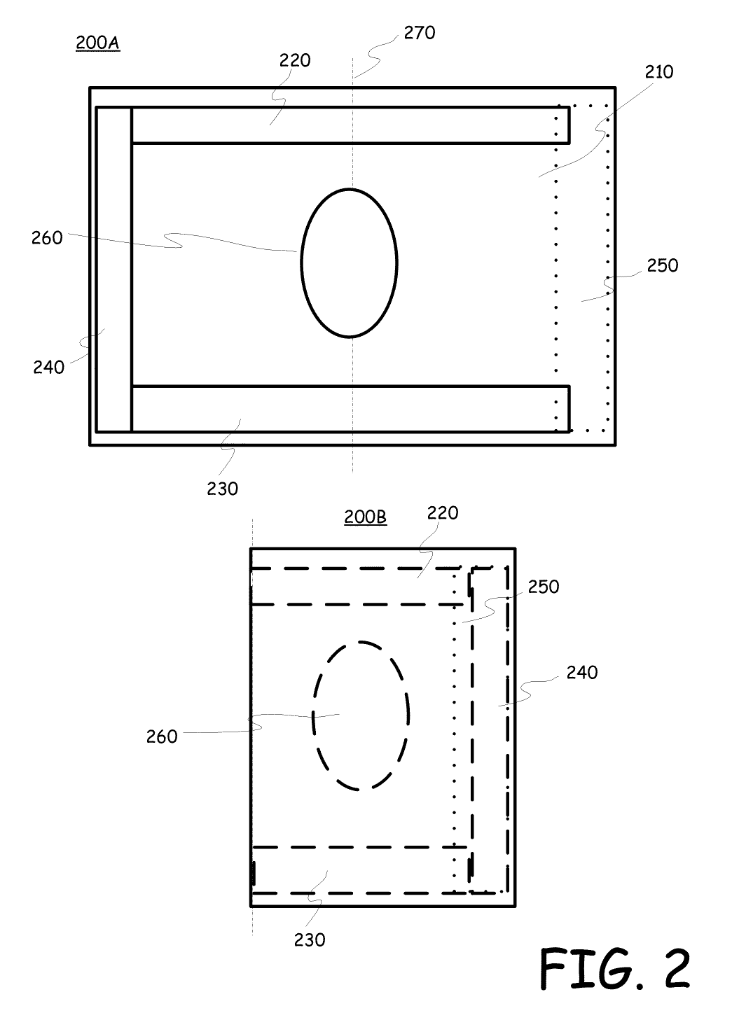

FIG. 2 is a conceptual diagram of another embodiment of a covering material. As previously described, the material can be one, two or multi-ply with various of the above described configurations. In addition, as a non-limiting example, covering material (as illustrated in its unused or dispensed state 200A) may include a sheet 210 with adhesive tape with peel-away strips located on several of the edges of the sheet (such as strip 220, 230 and 240) so that a user can fold edges over to create a pouch or bag. Thus, in the illustrated example, an item 260 can be placed onto the sheet 210 or picked up using the sheet 210. The protective strips can then be removed from the adhesive strips 220, 230 and 240 and the sheet can be folded across line 270 for form a pouch. The embodiments can be configured to mate with other adhesive strips or, as is the case with strips 220 and 230, to be folded over each other. For strip 240, a landing areal 250 is provided to which the adhesive strip can mate. Once the sheet 210 is folded over, adhesive strip 220 forms one side of the pouch, adhesive strip 230 forms another side of the pouch, the fold in the sheet 210 forms the bottom of the pouch and the top opening is sealed by adhesive strip 240 mating with landing area 250 to form the pouch 200B with the item 260 secured in the interior of the pouch.

The various embodiments of the covering material may be dispensed in a variety of ways, such as continuous roll, stacks, pleated or folds of tissues with or without perforations between sections to allow the user to withdraw a single sheet at a time, pop-up dispensers, individually packaged, etc.

In an exemplary embodiment suitable for disposal of used tampons, dimensions of the covering material or tissue are such that it can enclose the used tampon. The disposal system tissue consists of a size and shape sufficient to enclose a tampon and cover the users finger tips. Some example shapes may be rectangular, square, oblong or cupcake liner type piece of material with a fluid absorbent layer on one side and a fluid resistant layer on the other side. The dimensions of the tissue in such an embodiment are such that when folded in half, it can contain both the string of the tampon as well as the tampon itself. The tissue can be packaged in a roll, or pleated stack or folded such as C-folded, V-folded, Z-folded or any other manner typically used by the industry.

### Dispenser

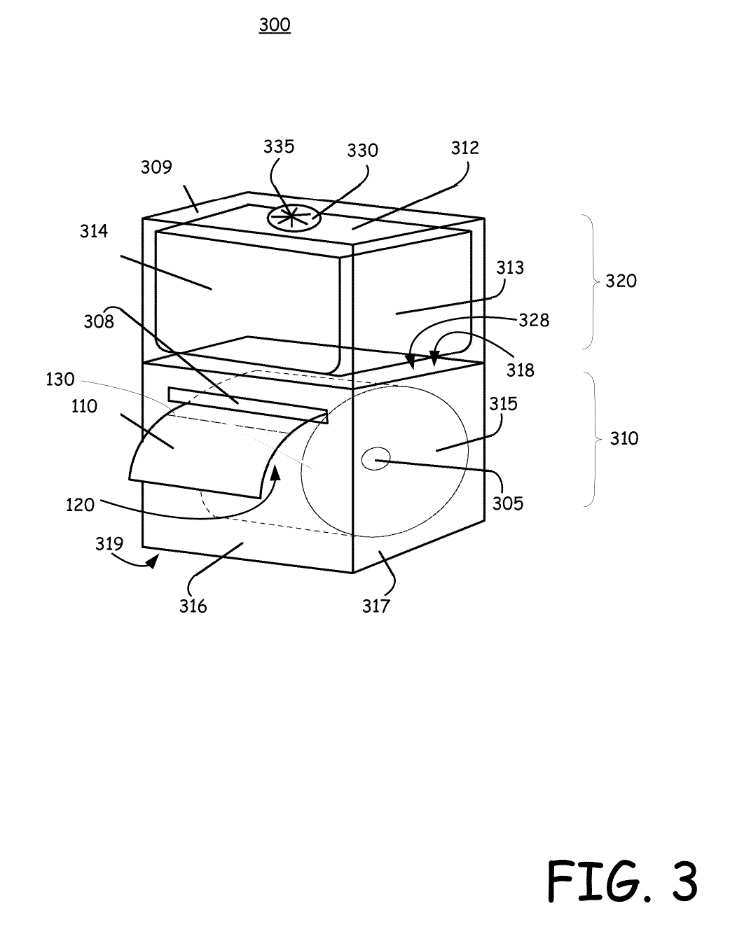

FIG. 3 is an upper perspective view of an exemplary embodiment of a waste product disposal system that includes a covering material dispenser and a waste product receptacle. In the illustrated embodiment, the dispenser is shown as being used to dispense a roll of sheets; however, other embodiments could be used to dispense, stacked or interfolded disposable sheets, or the like. The embodiment illustrated in FIG. 3 shows a perspective view with see through walls to reveal details related to the interior of the system. The waste product disposal system 300 includes a covering material dispenser 310 and a disposal system waste product receptacle 320. The covering material is illustrated as being packaged in a roll 315, as a non-limiting example. The covering material dispenser consists of a container 310 that houses the covering material (roll 315 in the illustrated embodiment). In exemplary embodiments the covering material dispenser allows for easy replacement or replenishment of the covering material such as through a side, top, front, rear or upper access panel or door or similar access mechanism. The tissue dispenser 310 allows dispensing of a single tissue each time it is accessed, or may limit the number of tissues dispensed to prevent overflow of the waste receptacle. The dispensing unit may be mounted to any flat surface, vertical or horizontal, as well as free standing design, mounted to a pole, pedestal or stand, hung over a partition wall by a hanger system, etc. The dispensing assembly can be of any sizes to accommodate a supply of covering material or the disposal container volume.

The dispensing container 315 may take on any desired geometric shape and size. In the illustrated embodiment, the container 315 includes a pair of sides or walls 317, end walls 316, a bottom wall 319, and a top wall 318. The walls define an interior volume sized for receipt of the covering material, which, in the illustrated embodiment of a roll 315, generally either rest on a spindle 305 or the bottom wall 319. Tissue sheets may be dispensed from the front, sides top or bottom of the container 315; however, for illustrative purposes the embodiment illustrated in FIG. 3 is shown as being dispensed from the front or end wall 316. The front wall 316, front facing of the dispensing container 315, includes a dispensing opening 308 for the user to grasp and remove a single sheet for use. The dispenser 315 may be manually, mechanically or electronically operated to dispense the various embodiments of the covering material.

In general the dispensing container 315 can be made from various materials. For instance, the container can be made from plastic, metal, stainless steel, fiberglass, paper board, recyclable material, or cardboard as a few non-limiting examples. Materials used to form the walls of the container can be rigid or flexible. The container may be wall mounted, free standing, portable and operated either manually or electronically for dispensing the covering material, such as single use sheets of tissues. The tissue dispenser may contain scents or anitbacterial, antimcrobial or similar properties to reduce odors and bacteria.

### Waste Receptacle

FIG. 3 also illustrates the structure of the disposal system's 300 waste receptacle 320. In the illustrated embodiment, the waste receptacle 320 is shown as being mounted on top of the dispenser 310. The waste receptacle 320 may take on any of a variety of geometric shapes and sizes. In the illustrated embodiment, the waste receptacle 320 includes a pair of sides or walls 313, end or front wall 314, a bottom wall 328 (which corresponds with or is placed adjacent to the top wall 318 of the dispenser container 310 in the illustrated embodiment), and a top wall 309. The walls define an interior volume sized for receiving disposed waste product items, such as used tampons wrapped in a covering material for the example embodiment. The top wall 309 contains an opening 330 of the push-through type or other means to semi-close the waste container 320. The opening 330 can be made from various materials to allow it to be replaced as needed, such as whenever a waste receptacle lining is replaced for example. The waste receptacle opening 330 provides for insertion of waste product wrapped in covering material and may be made of any suitable polymer, plastic, paper board or cardboard including an opening such as slits 335 for the consumer to push or drop the wrapped or covered waste product through the opening to be released into the waste receptacle 320. The opening can be disposable or replaceable, and may be located on the top, sides, or bottom of the waste container. In some embodiments, the opening may be a one-way port allowing waste product items to be inserted into the interior area of the waste receptacle but preventing their subsequent extraction. For instance, a one way hinged flap, similar to a garbage can door, can be used and when pressure is applied to the door, it opens to allow the waste product to be inserted but, if pressure is not applied, the door remains in a closed position and even if pressure is applied from the inside, the door cannot open in an outward direction.

In general the waste receptacle 320 can be made from various materials. For instance, the container can be made from plastic, metal, paper board, stainless steel, fiberglass, recyclable material or cardboard, and may be lined. Materials used to form the walls of the container can be rigid or flexible. The waste container 320 includes an opening 335 for receiving used sheets, and the waste receptacle may be lined with a disposable lining such as a waste bag, disposable box/cartridge or trash bag. In the illustrated embodiment, a disposable box 312 is shown in the interior of the waste receptacle 320. The waste receptacle 320 may also include a door, slot, push through door or lid, sliding door, manual, automatic, spring operated, electronically or mechanically opened access door for removal of the disposed contents and replacement of the disposable box 312 or other removable container. The waste container may be wall mounted, or free standing connected to the dispenser or separate from the dispenser and the opening may be operated either manually, automatically, mechanically or electronically. The waste container may contain scented or anitbacterial, or antimicrobial or similar properties to reduce odors.

The waste receptacle 320 can include a lining, such as the disposable box 312 in the illustrated embodiment, or may be a bag, trey or any of a variety of items to facilitate emptying of the waste receptacle 320. The lining can be removed from any side of the dispenser depending on the particular embodiment (i.e., front, back, sides) through an access that can be (but not limited to) a door, hatch, or slide. The liner 312 and the opening 330 may also be integral to each other such that when installed into the waste receptacle 320, the opening 330 is accessible through a hole in surface of the waste receptacle and, when the lining 312 is extracted, it is in essence a closed system with only the opening 330.

The opening 330 can be of any shape as long as it is sufficient in size to dispose of a wrapped tampon. The push through opening can consist of (but is not limited to) plastic, rubber or paper.

In some embodiments, the opening 330 can be only integral to the waste receptacle 320 and then potentially interface or connect with an opening in the lining. In embodiments where the opening 330 is integral to the waste receptacle 320, the opening can be as previously described or, it can be an automated hands free or touch-free type of system.

For instance, rather than a hole through which items are pushed, the opening 330 may be a lid that is lifted, either by manual means or electro-mechanical means. In addition, the lid may be activated by a motion sensor such that a user can then deposit the covered waste product without ever having to touch the waste receptacle. Thus, with a motion sensor and electro-mechanical devices included in the waste receptacle, the user can receive covering material, cover the waste product and then deposit the waste product into the waste receptacle 320 without ever coming into contact with the body of the waste receptacle 320 or dispenser 310. In other embodiments, the opening 330 may include an automatic feeder that is triggered when an end of a covered waste product is inserted, and it then proceeds to pull the remainder of the waste product into the waste receptacle 320 without any assistance from the user. Such embodiments would include safety measures to ensure that clothing, hair or body parts could not be inserted into the opening and trigger the automatic feed mechanism.

The relationship between the dispenser and the waste receptacle as illustrated in FIG. 3, is a non-limiting example on only one embodiment of the waste product system. Other configurations may also be utilized, such as having the waste receptacle under the dispenser with the opening 330 on the front or side, or having the waste receptacle on either side of the dispenser with the opening on the top or front or side. Likewise, the waste container and the dispenser can be totally separate components existing by themselves in some applications or, positioned in proximity to each other in other applications.

Looking at some specific examples of applications for the waste product disposal system, the embodiment of a used feminine hygiene product or tampon disposal system is now described in more detail. Looking at the embodiment illustrated in FIG. 3, a roll or stack of tissue is placed into the dispenser with the first tissue extending from an opening located in the front panel of the dispenser. One or more tissues can then be drawn out individually from the dispenser. The design of the dispenser may be such that it ensures that only one tissue at a time is dispensed to help conserve items.

The dispensed tissue is then used to grasp the tampon string that extends externally from the body of the tampon wearer. Pinching the tampon string with the dispensed tissue, the user extracts the used tampon from the body between the absorbent layer, next to the used tampon, and the fluid resistant layer next to the users finger tips. The outer fluid resistant layer keeps the user's hands clean and free of bodily fluids, while the inner absorbent layer attracts fluids keeping the user and the facility surroundings clean.

The soiled tampon is then cleanly wrapped and folded into the dispensed tissue and inserted into the opening of the waste receptacle 330.

One embodiment of the present invention includes a portable and/or disposable disposal system that includes a section for dispensing tissue for extraction and wrapping of a waste product item to be disposed of, and a waste receptacle for receiving the wrapped item. For instance, in one embodiment, the portable disposal system may be a one-time use that includes a single sheet for dispensing and can receive a single deposit. In other embodiments, multiple dispenser sheets can be housed and the multiple objects can be disposed within the waste receptacle. In either embodiment, the disposal system can be sized to be easily portable, such as able to neatly fit within the interior of a purse, back pack, etc.

In some embodiments, the disposal system can be permanently or semi-permanently attached to a wall or other installation device. In such embodiments, the disposal system can be reloaded with tissue and emptied of disposed items periodically. In other embodiments, the disposal system can be mounted in an area, such as a panel wall in a bathroom stall, but, be entirely disposable such that periodically, the disposal system can be removed to be discarded and replaced by a new disposal system. In yet other embodiments, the waste receptacle includes a waste cartridge that can be extracted periodically for disposal and a new cartridge placed therein.

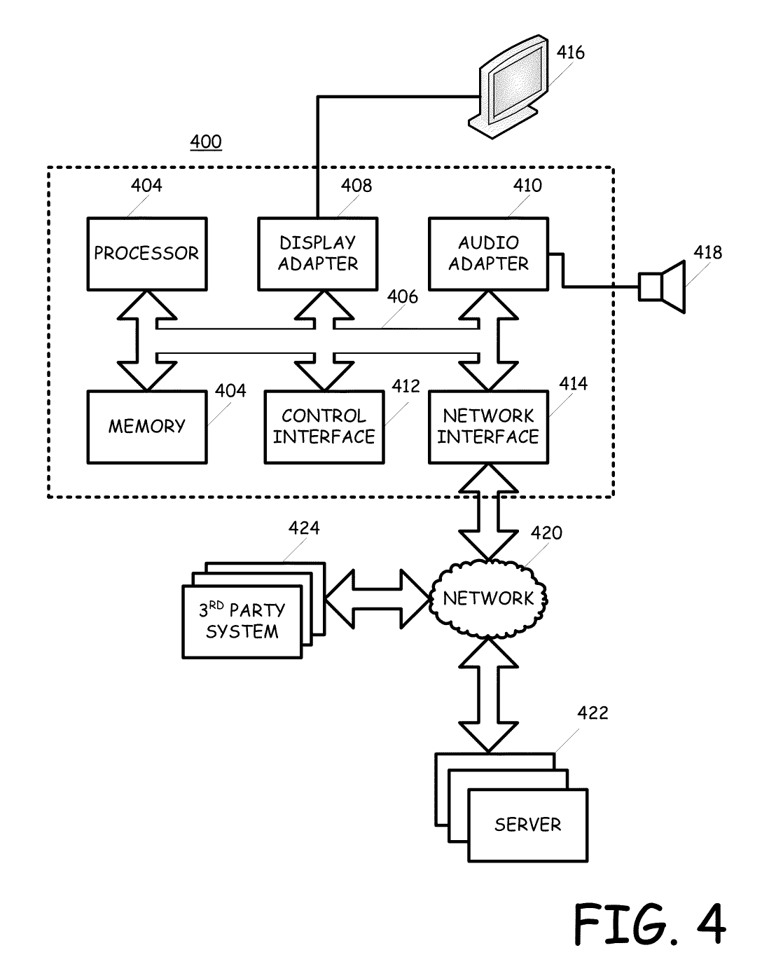

FIG. 4 is a functional block diagram of the components of an exemplary embodiment of system or sub-system operating as a controller or processor 400 that could be used in various embodiments of the disclosure for controlling aspects of the various embodiments. It will be appreciated that not all of the components illustrated in FIG. 4 are required in all embodiments of the waste product disposal system but, each of the components are presented and described in conjunction with FIG. 4 to provide a complete and overall understanding of the components. The controller can include a general computing platform 400 illustrated as including a processor/memory device 402/404 that may be integrated with each other or, communicatively connected over a bus or similar interface 406. The processor 402 can be any of a variety of processor types including, but not limited to, microprocessors, micro-controllers, programmable arrays, custom IC's etc. and may also include single or multiple processors with or without accelerators or the like. The memory element of 404 may include a variety of structures, including but not limited to RAM, ROM, magnetic media, optical media, bubble memory, FLASH memory, EPROM, EEPROM, etc. The processor 402, or other components in the controller may also provide elements such as a real-time clock, analog to digital convertors, digital to analog convertors, etc. The processor 402 also interfaces to a variety of elements including a control interface 412, a display adapter 408, an audio adapter 410, and network/device interface 414. The control interface 412 provides an interface to external controls, such as sensors, actuators, drawing heads, nozzles, cartridges, pressure actuators, leading mechanism, drums, step motors, a keyboard, a mouse, a pin pad, an audio activated device, as well as a variety of the many other available input and output devices or, another computer or processing device or the like. The display adapter 408 can be used to drive a variety of alert elements 416, such as display devices including an LED display, LCD display, one or more LEDs or other display devices. The audio adapter 410 interfaces to and drives another alert element 418, such as a speaker or speaker system, buzzer, bell, etc. The network/interface 414 may interface to a network 420 which may be any type of network including, but not limited to the Internet, a global network, a wide area network, a local area network, a wired network, a wireless network or any other network type including hybrids. Through the network 420, or even directly, the controller 400 can interface to other devices or computing platforms such as one or more servers 422 and/or third party systems 424. A battery or power source provides power for the controller 400.

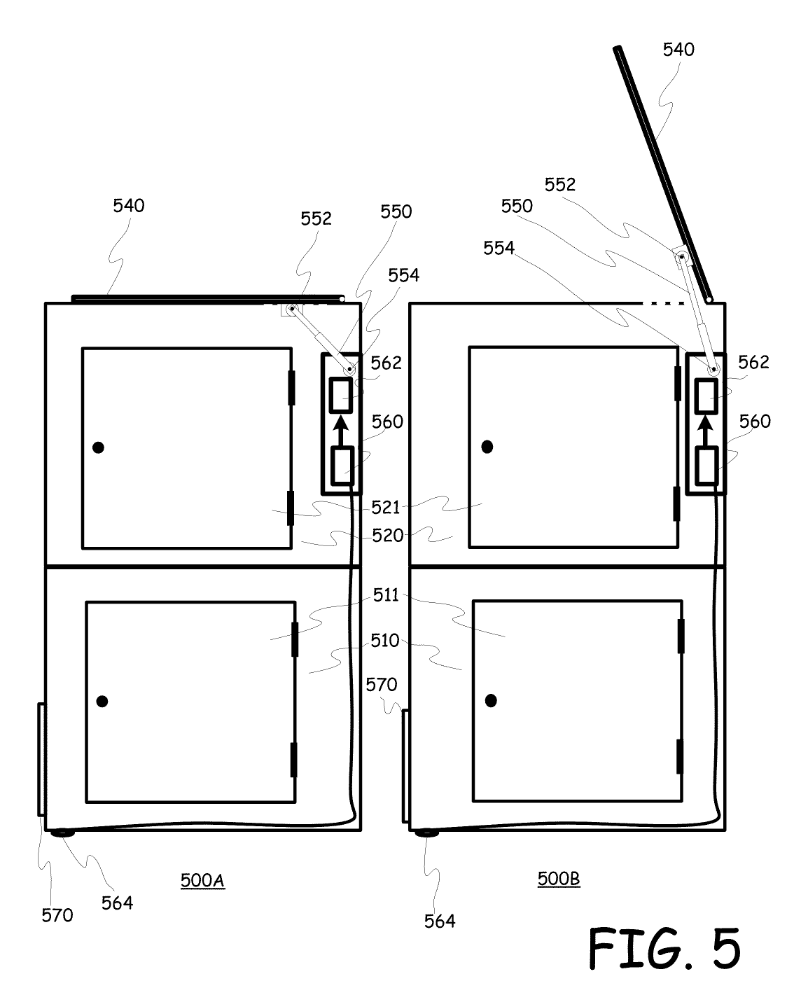

FIG. 5 is a diagram illustrating an embodiment of the waste product disposal system with an hands free, touch-free access to the waste product receptacle. In the illustrated embodiment, a dispenser 510, which may include an access panel 511, is shown mounted below the waste product receptacle 520, which may include an access panel 521. An opening into the waste product receptacle is provided on the top panel of the waste product receptacle and a hinged access panel 540 is positioned over the opening in the closed state 500A. A controller 560 interfaces with a motor 562 and an actuator 564. The actuator 564 may be a motion detector of a variety of types. The actuator 564 is illustrated as being placed under the dispenser 510 so as not to be inadvertently triggered and, a user can simply wave a hand below the actuator 564 to trigger the motion detector. The access panel 540 is hinged to the top of the waste product receptacle 520 and is coupled to the motor 562 by a telescoping arm 550 at a pivoting joint 554 proximate to the motor and a pivoting joint 552 attached to the underside of the access panel 540.

In operation, a user needing to deposit waste product, can wave a hand below the actuator 564 which will result in sending a signal to the controller 560. In response to the signal, the controller 560 actuates the motor 562 which then begins to expand the telescoping arm 550. As the telescoping arm 550 expands, the arm pivots at the pivoting points and forces the hinged access panel 540 to raise thereby exposing the opening into the waste product receptacle 520 as shown in state 500B. The user can then deposit the waste product into the waste product receptacle 520. The controller may include a timer to automatically invoke the lowering of the access panel 540 after a delay period. It should be appreciated that using a telescoping arm and a hinged panel is only one technique to provide access to the interior of the waste receptacle. In general, the panel can be displaced by a variety of means including sliding, swinging outwardly, swinging inwardly, rotating to the side, etc.

Some embodiments of the waste product disposal system may include a display to provide status information and/or instructions. Such a feature is illustrated in FIG. 5. The display 570 can be communicatively coupled to the controller 560 and display information provided by the controller 560. As a non-limiting example, the display can be used to instruct a user to wave his or her hand below the dispenser to activate the opening of the access panel. Likewise, the display can be used to provide a status indicator such as “ready”, “full”, “service required”, “service required please call 404-555-2849”. In some embodiments, the controller 560 may simply count the number of times that the access panel 540 has been opened and determine if the waste product receptacle 520 is full based on this information. In other embodiments, a sensor may be used to determine if the waste product receptacle is full 520.

In some embodiments, the controller 560 or a similar controller may be used to feed covering material from the dispenser 510. Thus, similar to a touch-free towel dispenser, a motion sensor can be used to trigger the controller to feed a unit of the covering material. As a non-limiting example, referring again to FIG. 5, the user could wave a hand below the actuator 564 to trigger the dispensing of a unit of the covering material. The actuation may also invoke the opening of the access panel 540 or, a subsequent actuation of the same actuator or an additional actuator may invoke the opening of the access panel 540.

In some embodiments, the controller may include a communications module to communicate status pertaining to the waste product disposal system to a central control system that provides maintenance. The communications module may be wireless, such as cellular, WIFI, BLUETOOTH, etc., or it may be a wired interface. In some embodiments, an audible interface may be used to alert that the waste receptacle is full, needs maintenance, provide verbal instructions, etc.

In various embodiments, the access panel to the waste product receptacle may take on a variety of forms, such as a sliding door, a hinged door, a removable door, etc. In general, access is provided in non-disposable versions of the waste product disposal system to enable removal of waste product, waste product linings, waste product receiver boxes, etc., and to facilitate cleaning of the interior. In some embodiments, the waste product receptacle and be removed and placed into a washer or sanitizing station.

What has been described and illustrated herein is a preferred embodiment of the disposal system along with some of its variations. The terms, descriptions and figures used herein are set forth by way of illustration only and are not meant as limitations. Those skilled in the art will recognize that many variations are possible within the spirit and scope of the invention in which all terms are meant in their broadest, reasonable sense unless otherwise indicated. Any headings utilized within the description are for convenience only and have no legal or limiting effect.

What is claimed is:

1. A waste product disposal system comprising:
a covering material dispenser;
a waste receptacle defining an interior area and comprising an opening into the interior area through which waste product items can be inserted into the interior area; and
a covering material, wherein the covering material includes a first side with a surface that is at least partially constructed of a non-porous material and a second side with a surface that is at least partially constructed of an element absorbing material.

2. The waste product disposal system of claim 1, wherein the second side of the covering material is liquid absorbent.

3. The waste product disposal system of claim 1, wherein the second side of the covering material is particle absorbent.

4. The waste product disposal system of claim 1, wherein the opening into the interior area of the waste receptacle is a one-way port through which waste product items that are wrapped in the covering material can be inserted into the interior area of the waste receptacle and once inserted, they cannot be retrieved through the opening.

5. The waste product disposal system of claim 1, wherein the waste receptacle and the covering material dispenser are separate units.

6. The waste product disposal system of claim 5, wherein the waste receptacle is disposable, wherein the waste receptacle can be disposed of without having to remove the waste product items from the interior area of the waste receptacle.

7. The waste product disposal system of claim 1, wherein the waste receptacle includes a liner, located within the interior area of the waste receptacle, into which the waste product items are placed.

8. The waste product disposal system of claim 7, wherein the waste receptacle includes an access panel to enable insertion and extraction of the liner.

9. The waste product disposal system of claim 1, wherein the waste receptacle includes an access penal to enable the extraction of waste product items.

10. The waste product disposal system of claim 1, further comprising:
a panel for covering the opening into the interior area of the waste receptacle; and
an actuating device for displacement of the panel thereby granting access to the interior area through the opening.

11. The waste product disposal system of claim 10, wherein the panel is attached to the waste receptacle with a hinge and the actuating device is a telescoping arm that can raise and lower the panel in a hinged fashion.

12. The waste product disposal system of claim 10, wherein the actuating device is triggered by a motion sensor.

13. The waste product disposal system of claim 1, further comprising:
a panel for covering the opening into the interior area of the waste receptacle;
an actuating device for displacement of the panel thereby granting access to the interior area through the opening; and
a controller for causing the actuating device to displace the panel to an open position and return the panel to a closed position.

14. The waste product disposal system of claim 13, further comprising a motion sensor communicatively coupled to the control and configured to detect motion and in response to the detection of motion, causing the actuating device to displace the panel.

15. The waste product disposal system of claim 14, wherein the controller automatically causes the actuating device to return the panel to the closed position after a delay of time.

16. The waste product disposal system of claim 15, wherein the controller is further configured to automatically dispense single units of the covering material.

17. The waste product disposal system of claim 1, wherein the second side of the covering material is partially constructed of a liquid absorbing material and partially constructed of a particle absorbing material.

18. The waste product disposal system of claim 17, wherein the particle absorbing material is a non-woven fabric.

19. The waste product disposal system of claim 17, wherein the liquid absorbing material and the particle absorbing material are interlaced.

20. The waste product disposal system of claim 17, wherein the particle absorbing material is positioned on top of the liquid absorbing material.
